(19) United States
(12) Patent Application Publication
(10) Pub. No.: US 2018/0156105 A1
(43) Pub. Date: Jun. 7, 2018

(54) SUPERCHARGER

(71) Applicant: TOYOTA JIDOSHA KABUSHIKI KAISHA, Toyota-shi (JP)

(72) Inventor: Osamu IGARASHI, Toyota-shi (JP)

(73) Assignee: TOYOTA JIDOSHA KABUSHIKI KAISHA, Toyota-shi (JP)

(21) Appl. No.: 15/807,702

(22) Filed: Nov. 9, 2017

(30) Foreign Application Priority Data
Dec. 6, 2016 (JP) 2016-236846

(51) Int. Cl. F02B 37/18

(52) U.S. Cl. CPC F02B 37/186; F01D 25/24

(57) ABSTRACT

A supercharger includes: a turbine housing including a bypass passage configured to cause an exhaust gas to flow so as to detour around a turbine wheel; and a wastegate valve configured to controlling an amount of the exhaust gas flowing through the bypass passage. The wastegate valve includes a valve body including a valve plate and a valve stem, a support portion having a support hole, a shaft, and a rotating mechanism configured to rotate the shaft. The valve body is assembled to the support portion in a state where the valve stem is passed through the support hole, and rotates along with rotation of the shaft. In an axial direction, a clearance between the valve stem and the support plate in an axial direction of the shaft is smaller than a clearance between the valve stem and the support plate in an orthogonal direction perpendicular to the axial direction.

### CROSS-REFERENCE TO RELATED APPLICATIONS

This application claims priority to Japanese Patent Application No. 2016-236846 filed on Dec. 6, 2016, which is incorporated herein by reference in its entirety.

### BACKGROUND

### Technical Field

The present disclosure relates to a supercharger.

### Description of Related Art

A supercharger described in Published Japanese Translation of PCT Application No. 2015-500955 (JP-A-2015-500955) includes a turbine housing in which a turbine wheel is accommodated. The turbine housing is provided with a bypass passage through which an exhaust gas flows so as to detour around the turbine wheel. The supercharger is also provided with a wastegate valve for controlling an amount of the exhaust gas flowing through the bypass passage.

The wastegate valve includes a valve body, and an operating member for rotating the valve body. The operating member includes a columnar shaft extending so as to penetrate through the turbine housing from outside to inside. The shaft is rotatably supported by a bush fixed to the turbine housing. The shaft is configured such that a support portion extending in a radial direction of the shaft is connected to one end of the shaft, the one end being placed inside the turbine housing. A support hole is formed in the support portion. The valve body is constituted by a disciform valve plate, and a valve stem provided in a standing manner from the valve plate. The valve stem is passed through the support hole of the support portion, and a washer is attached to a tip end thereof. The washer restrains the valve stem from falling out of the support portion. As such, the support portion is placed between the valve plate and the washer, and the valve body is assembled to the operating member. The valve stem has a circular section, and the support hole is formed to have a circular shape with a larger diameter than the valve stem. That is, a predetermined clearance is provided between the valve stem and the support portion, and inclination of the valve body to the support portion is hereby permitted.

A rotating mechanism for rotating the shaft is connected to the other end of the shaft, the other end being placed outside the turbine housing. When the rotating mechanism rotates the shaft, the valve body rotates in a circumferential direction of the shaft. In the wastegate valve, the valve body is rotated so as to close and open an outlet portion of the bypass passage, thereby controlling an amount of the exhaust gas passing through the bypass passage.

### SUMMARY

In the supercharger described in JP-A-2015-500955, a clearance is provided between the valve stem and the support portion in the wastegate valve. This clearance permits inclination of the valve body to the support portion, thereby increasing a sitting property of the valve body to the turbine housing when the bypass passage is closed. Meanwhile, when the clearance is provided between the valve stem and the support portion, the exhaust gas flowing through the bypass passage might collide with the valve body, so that the valve body might vibrate. The supercharger has an object to balance securing of the sitting property of the valve body with restraint of vibrations thereof.

In order to achieve the above object, the present disclosure provides a supercharger that balances a sitting property of a valve body with restraint of vibrations of the valve body. In view of this, according to one aspect of the present disclosure, a supercharger including a turbine housing and a wastegate valve is provided. The turbine housing includes a bypass passage configured to cause exhaust gas to flow so as to detour around a turbine wheel. The wastegate valve is configured to control an amount of the exhaust gas flowing through the bypass passage. The wastegate valve includes a valve body, a support portion, a shaft, and a rotating mechanism. The valve body includes a valve plate, and a valve stem provided in a standing manner from the valve plate in a thickness direction of the valve plate. The support portion includes a support hole through which the valve stem is passed. The support portion is connected to the shaft. The rotating mechanism is configured to rotate the shaft. (i) The valve body is assembled to the support portion in a state where the valve stem is passed through the support hole. (ii) The valve body is configured to rotate along with rotation of the shaft. (iii) When the valve stem is viewed in an axial direction of the valve stem, a clearance between the valve stem and the support portion in the axial direction of the shaft is smaller than a clearance between the valve stem and the support portion in an orthogonal direction perpendicular to the axial direction of the shaft.

The wastegate valve rotates the valve body around the shaft so as to abut with the turbine housing, thereby closing the bypass passage. The shaft may be inclined at the time when the shaft is rotationally operated by the rotating mechanism. In a case where an arrangement of the shaft is changed due to inclination of the shaft or the like, when the valve body rotates, a whole peripheral edge of the valve plate might not sit on the turbine housing evenly, so that a part of its rotation locus on an outer peripheral side or an inner peripheral side might make partial contact with the turbine housing. With the configuration of such a supercharger, a clearance between the valve stem and the support portion in the orthogonal direction perpendicular to the axial direction of the shaft is larger than a clearance between the valve stem and the support portion in the axial direction of the shaft. Accordingly, the valve body is permitted to be inclined to the support portion around the axial direction of the shaft. Accordingly, even in a state where the arrangement of the shaft is changed and the part of the valve plate makes partial contact with the turbine housing, the shaft is further rotated to incline the valve body relative to the support portion, so that the whole peripheral edge of the valve plate can be seated on the turbine housing. Hereby, a sitting property of the valve body can be secured.

In order that the whole peripheral edge of the valve plate is seated on the turbine housing from the state where the partial contact of the valve plate occurs, it is necessary to secure the clearance between the valve stem and the support portion in the orthogonal direction. Meanwhile, the clearance between the valve stem and the support portion in the axial direction of the shaft has little influence on the sitting property of the valve body to the turbine housing. In the configuration of such a supercharger, the clearance provided between the valve stem and the support portion in the axial direction of the shaft and having little influence on the sitting property is made small. Accordingly, it is possible to secure the sifting property of the valve body and it is also possible to restrain movement of the valve body relative to the support portion in the axial direction of the shaft, thereby making it possible to restrain vibrations caused due to the movement. Accordingly, with the configuration of such a supercharger, it is possible to balance a function to secure the sitting property of the valve body to the turbine housing with a function to restrain vibrations of the valve body.

Further, in the supercharger, the support hole may have an oval shape, and a sectional shape of the valve stem may be formed in an oval shape. With the configuration of such a supercharger, curved surfaces of the valve stem and the support portion can make contact with each other. This makes it possible to restrain abrasion of the valve stem and the support portion, which can contribute to an increase of durability.

Further, in the supercharger, the valve stem may extend from the valve plate so as to penetrate through the support hole, and a connecting plate may be connected to a tip end thereof projecting from the support portion. An elastic member may be sandwiched at least between the valve plate and the support portion or between the support portion and the connecting plate.

In the configuration of such a supercharger, the elastic member is sandwiched in the axial direction of the valve stem. The elastic member restrains the inclination of the valve body by its elastic force. Accordingly, with the above configuration, it is possible to increase the function to restrain vibrations of the valve body.

Further, in the supercharger, (i) the turbine housing may include a first scroll passage and a second scroll passage each configured to lead the exhaust gas to the turbine wheel. (ii) The bypass passage may include a first bypass passage and a second bypass passage. The first bypass passage may be branched from a middle of the first scroll passage and configured to cause the exhaust gas to flow so as to detour around the turbine wheel. The second bypass passage may be branched from a middle of the second scroll passage and configured to cause the exhaust gas to flow so as to detour around the turbine wheel. (iii) An opening of the first bypass passage and an opening of the second bypass passage may be placed side by side in the axial direction of the shaft. (iv) The wastegate valve may be configured to close and open respective openings of the first bypass passage and the second bypass passage by means of one valve body, so as to control respective amounts of the exhaust gases flowing through the first bypass passage and the second bypass passage.

In the configuration where one valve body closes and opens respective openings of the first bypass passage and the second bypass passage, the exhaust gas exhausted from the first bypass passage and the exhaust gas exhausted from the second bypass passage might collide with the valve body alternately. On that account, the valve body tends to easily vibrate.

In the configuration of such a supercharger, the openings of the first bypass passage and the second bypass passage are placed side by side in the axial direction of the shaft. Thus, by placing the openings in a direction where the function to restrain vibrations of the valve body is easily obtained, it is possible to further effectively obtain the function to restrain vibrations of the valve body.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view illustrating a configuration of a supercharger of an embodiment as one example of the present disclosure;

FIG. 2 is a sectional view of the supercharger illustrated in FIG. 1;

FIG. 3 is a partial sectional view illustrating a configuration of a turbine housing of the supercharger when viewed from an outlet side;

FIG. 4 is a sectional view of a valve stem and a support portion of a wastegate valve of the supercharger;

FIG. 5 is a sectional view taken along a line 5-5 illustrated in the partial sectional view of FIG. 3;

FIG. 6 is a sectional view illustrating a change state of a position of a valve body at the time when an arrangement of a shaft of the supercharger is changed;

FIG. 7 is a sectional view illustrating a rotation state of the valve body at the time when the arrangement of the shaft of the supercharger is changed;

FIG. 8 is a sectional view illustrating a sitting state of the valve body at the time when the arrangement of the shaft of the supercharger is changed;

FIG. 9 is a sectional view schematically illustrating a collision state of exhaust gases flowing through a first bypass passage and a second bypass passage with respect to the valve body;

FIG. 10 is a sectional view illustrating a modification of the valve stem and a through-hole of the wastegate valve of the supercharger;

FIG. 11 is a sectional view illustrating another modification of the valve stem; and

FIG. 12 is a sectional view illustrating further another modification of the valve stem and the through-hole.

### DETAILED DESCRIPTION OF EMBODIMENTS

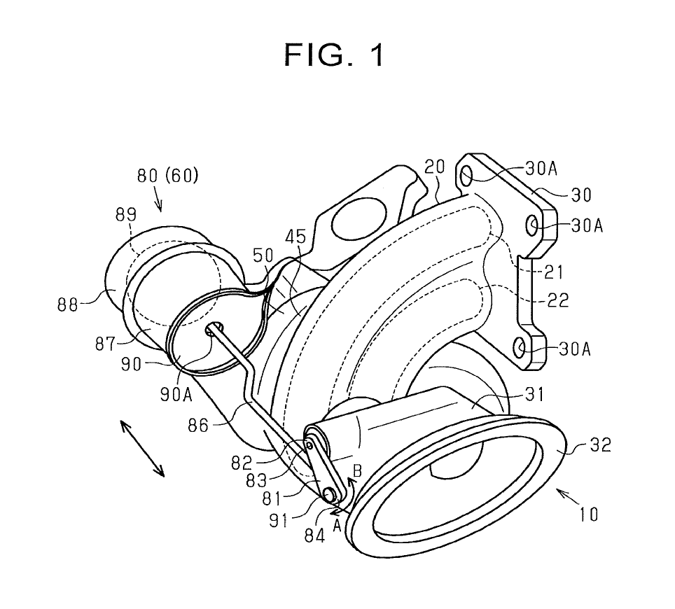

One embodiment of a supercharger is described below with reference to FIGS. 1 to 9. Note that the present embodiment shows an example in which the supercharger is applied to an inline four-cylinder internal combustion engine. As illustrated in FIG. 1, the supercharger includes a turbine housing 10. The turbine housing 10 includes a scroll portion 20 extending in a circumferential direction. A first scroll passage 21 and a second scroll passage 22 are formed in the scroll portion 20. A first flange 30 having a plate shape is connected to one end of the scroll portion 20. A plurality of insertion holes 30A is formed in the first flange 30. A bolt (not shown) is passed through to each insertion hole 30A, and then, the bolt is fastened to a bolt hole of a cylinder head (not shown), so that the turbine housing 10 is assembled to the cylinder head. An exhaust gas exhausted from an exhaust port of the cylinder head flows into the first scroll passage 21 and the second scroll passage 22. The cylinder head includes a plurality of exhaust ports formed so as to correspond to a first cylinder #1 to a fourth cylinder #4 placed in series to each other. The exhaust gas flows into the first scroll passage 21 from respective exhaust ports placed so as to correspond to the first cylinder #1 and the fourth cylinder #4. Further, the exhaust gas flows into the second scroll passage 22 from respective exhaust ports placed so as to correspond to the second cylinder #2 and the third cylinder #3. An ignition order of the cylinders in the internal combustion engine is an order of the first cylinder #1, the third cylinder #3, the fourth cylinder #4, and the second cylinder #2. Accordingly, the exhaust gas flows in to the first scroll passage 21 and the second scroll passage 22 alternately.

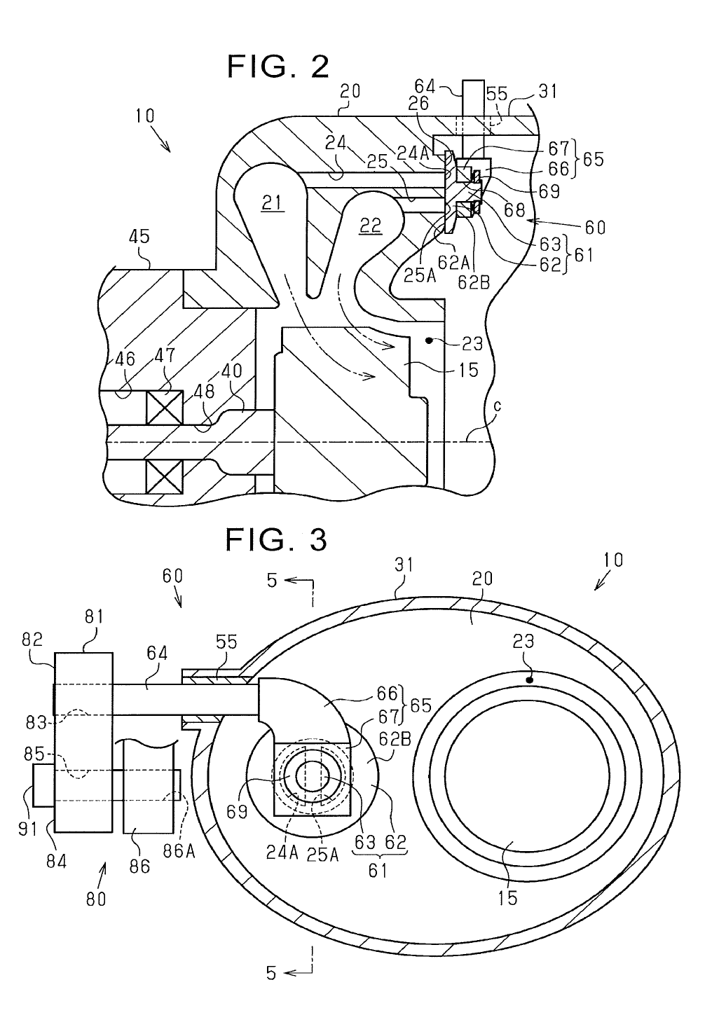

As illustrated in FIG. 2, the scroll portion 20 is also provided with an accommodation chamber 23 in which a turbine wheel 15 is accommodated. The first scroll passage 21 and the second scroll passage 22 extend around the accommodation chamber 23 in a circumferential direction, and their inner peripheral parts communicate with the accommodation chamber 23. One end of a rotating shaft 40 is connected to the turbine wheel 15. The rotating shaft 40 is passed through to a bearing housing 45 connected to one end (a left end in FIG. 2) of the scroll portion 20. An accommodation space 46 is formed inside the bearing housing 45, and a bearing 47 is placed in the accommodation space 46. A communicating hole 48 extending from an end surface on the turbine wheel 15 side to the accommodation space 46 is also formed in the bearing housing 45. The communicating hole 48 is increased in diameter on the turbine wheel 15 side. The rotating shaft 40 is passed through the communicating hole 48 and an inner side of the bearing 47 of the accommodation space 46. In a state where the rotating shaft 40 is passed through, a shape of the rotating shaft 40 is the same as a shape of the communicating hole 48, and the rotating shaft 40 is slidable on an inner wall of the communicating hole 48 in a circumferential direction. In a state where one end (a right end in FIG. 2) of the rotating shaft 40 projects from the bearing housing 45, the rotating shaft 40 is rotatably supported by the bearing 47 accommodated in the accommodation space 46. The turbine wheel 15 rotates integrally with the rotating shaft 40 around an axis C of the rotating shaft 40. As indicated by alternate long and two short dashes lines in FIG. 2, respective flows of exhaust gases led out toward the turbine wheel 15 from the first scroll passage 21 and the second scroll passage 22 are directed toward an extending direction of the axis C of the rotating shaft 40 (hereinafter referred to as an “extending direction”) at the time when the exhaust gases pass through the turbine wheel 15.

A tubular portion 31 is connected to the other end (a right end in FIG. 2) of the scroll portion 20, the other end being on an opposite side to one end to which the bearing housing 45 is connected. The tubular portion 31 has an elliptical tubular shape, and is connected to a peripheral edge of the other end of the scroll portion 20. As illustrated in FIG. 1, a second flange 32 is connected to an end of the tubular portion 31. An exhaust pipe (not shown) is connected to the second flange 32. Accordingly, the exhaust gases passing through the turbine wheel 15 from the first scroll passage 21 and the second scroll passage 22 and flowing in the extending direction are exhausted to the exhaust pipe through the tubular portion 31. The turbine wheel 15 rotates by such flows of the exhaust gases. A compressor wheel (not shown) is connected to the other end of the rotating shaft 40. When the turbine wheel 15 rotates, the compressor wheel rotates, so as to force-feed intake air flowing through an intake passage to each cylinder (#1 to #4). Note that, as illustrated in FIG. 1, the compressor wheel is accommodated in a compressor housing 50 connected to the bearing housing 45.

As illustrated in FIG. 2, in the scroll portion 20, a first bypass passage 24 branched from a middle of the first scroll passage 21, and a second bypass passage 25 branched from a middle of the second scroll passage 22 are also formed. The first bypass passage 24 extends from the first scroll passage 21 in the extending direction (a right-left direction in FIG. 2), and one end thereof is opened in an end surface 26 of the scroll portion 20 on the tubular portion 31 side. That is, the first bypass passage 24 communicates the first scroll passage 21 with an inner region of the tubular portion 31 without the accommodation chamber 23. The first bypass passage 24 causes the exhaust gas to detour around the turbine wheel 15 from the first scroll passage 21 and flow into the tubular portion 31.

The second bypass passage 25 extends from the second scroll passage 22 in the extending direction, and one end thereof is opened in the end surface 26 of the scroll portion 20 on the tubular portion 31 side. That is, the second bypass passage 25 communicates the second scroll passage 22 with the inner region of the tubular portion 31 without the accommodation chamber 23. The second bypass passage 25 causes the exhaust gas to detour around the turbine wheel 15 from the second scroll passage 22 and flow into the tubular portion 31.

As illustrated in FIG. 3, an opening 24A of the first bypass passage 24 and an opening 25A of the second bypass passage 25 are formed in a semicircular shape and placed so that their linear portions are opposed to each other. That is, the opening 24A of the first bypass passage 24 and the opening 25A of the second bypass passage 25 are placed so as to form a circular shape as a whole.

The supercharger is also provided with a wastegate valve 60 for controlling respective amounts of the exhaust gases flowing through the first bypass passage 24 and the second bypass passage 25. As illustrated in FIGS. 2 and 3, the wastegate valve 60 has a valve body 61. The valve body 61 is constituted by a disciform valve plate 62, and a valve stem 63 provided in a standing manner from the valve plate 62 in a thickness direction of the valve plate 62. The valve plate 62 is set to have a size that can close both openings 24A, 25A of the first bypass passage 24 and the second bypass passage 25 when the valve plate 62 abuts with the end surface 26 of the scroll portion 20. The valve stem 63 is connected to a back surface 62B on an opposite side to an abutting surface 62A of the valve body 61, the abutting surface 62A abutting with the end surface 26, and extends in a direction distanced from the end surface 26.

As illustrated in FIG. 3, the wastegate valve 60 includes a shaft 64, and a support portion 65 connected to the shaft 64. The shaft 64 is formed in a columnar shape and extends so as to penetrate through the tubular portion 31 of the turbine housing 10. The opening 24A of the first bypass passage 24 and the opening 25A of the second bypass passage 25 are placed side by side in an axial direction (a right-left direction of FIG. 3) of the shaft 64. The shaft 64 is passed through a bush 55 fixed to the tubular portion 31. The shaft 64 is rotatably supported by the bush 55. The support portion 65 is connected on one end (a right end in FIG. 3) of the shaft 64, the one end being placed inside the turbine housing 10. The support portion 65 is constituted by a fan-shaped curved portion 66 curving in an orthogonal direction (downward in FIG. 3) perpendicular to the axial direction of the shaft 64 from the one end of the shaft 64, and a support plate 67 connected to a bottom end of the curved portion 66. The support plate 67 is formed in a square plate shape. As illustrated in FIG. 2, a support hole 68 is formed in a center of the support plate 67. The valve stem 63 is passed through the support hole 68.

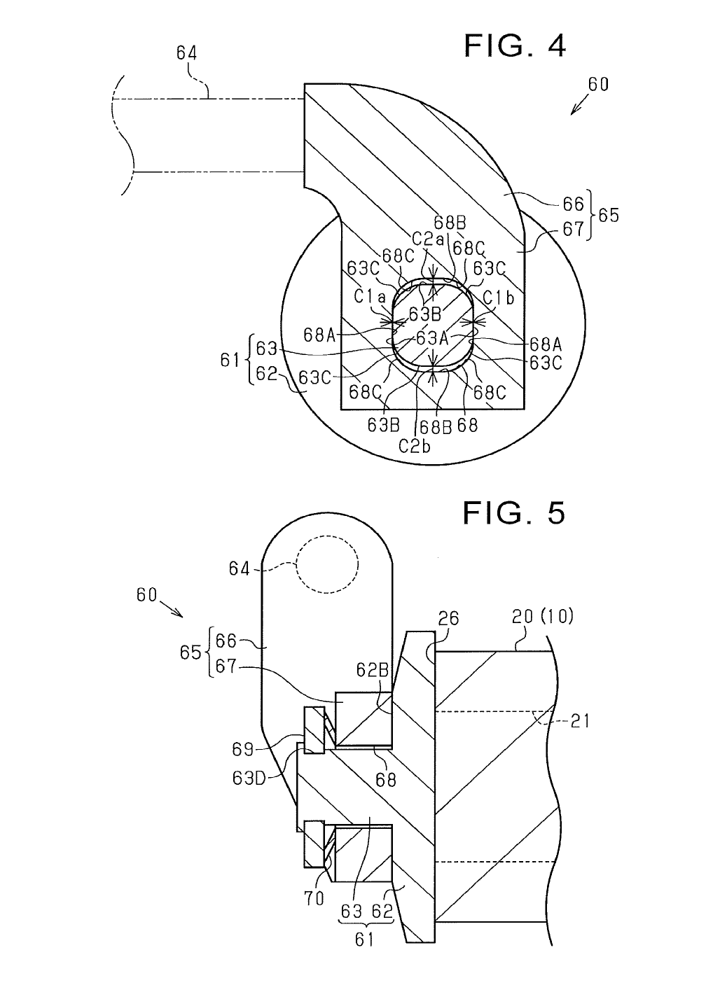

As illustrated in FIG. 4, a section of the valve stem 63 is formed in an oval shape with its short direction being along the axial direction (a right-left direction in FIG. 4) of the shaft 64 and its longitudinal direction being along an orthogonal direction (an up-down direction in FIG. 4) perpendicular to the axial direction. That is, when the valve stem 63 is viewed in the axial direction as illustrated in FIG. 4, the valve stem 63 is constituted by a pair of vertical walls 63A extending in the longitudinal direction (the up-down direction in FIG. 4), a pair of lateral walls 63B extending in the short direction (the right-left direction in FIG. 4), and curved walls 63C placed at four corners so as to connect the vertical walls 63A and the lateral walls 63B. Further, the support hole 68 formed in the support plate 67 is also formed in an oval shape with its short direction being along the axial direction of the shaft 64 and its longitudinal direction being along the orthogonal direction. That is, when the valve stem 63 is viewed in the axial direction as illustrated in FIG. 4, the support hole 68 is constituted by a pair of vertical inner walls 68A extending in the longitudinal direction (the up-down direction in FIG. 4), a pair of lateral inner walls 68B extending in the short direction (the right-left direction in FIG. 4), and curved inner walls 68C placed at four corners so as to connect the vertical inner walls 68A and the lateral inner walls 68B. A distance between the pair of lateral inner walls 68B in the support hole 68 is longer than a distance between the pair of lateral walls 63B in the valve stem 63. Meanwhile, a distance between the pair of vertical inner walls 68A in the support hole 68 is approximately equal to a distance between the pair of vertical walls 63A in the valve stem 63. Accordingly, when the valve stem 63 is viewed in the axial direction, a clearance C1 between the valve stem 63 and the support portion 65 in the axial direction of the shaft 64 is smaller than a clearance C2 between the valve stem 63 and the support portion 65 in the orthogonal direction (C1<C2). Note that the clearance C1 is a clearance obtained as a sum of a clearance C1a between the vertical wall 63A of the valve stem 63 on one side and the vertical inner wall 68A of the support hole 68 on the one side, and a clearance C1b between the vertical wall 63A of the valve stem 63 on the other side and the vertical inner wall 68A of the support hole 68 on the other side (C1=C1a+C1b). Further, the clearance C2 is a clearance obtained as a sum of a clearance C2a between the lateral wall 63B of the valve stem 63 on one side and the lateral inner wall 68B of the support hole 68 on the one side, and a clearance C2b between the lateral wall 63B of the valve stem 63 on the other side and the lateral inner wall 68B of the support hole 68 on the other side. That is, C2=C2a+C2b is satisfied.

As illustrated in FIG. 5, the valve stem 63 extends so as to penetrate through the support hole 68, and a washer 69 as a connecting plate is connected to a tip end thereof projecting from the support plate 67. The washer 69 is formed in an annular shape. A recessed groove 63D is formed in the tip end of the valve stem 63 over a whole circumference. An outside diameter of the recessed groove 63D is the same as an inside diameter of the washer 69. The washer 69 is placed in the recessed groove 63D. In a state where the washer 69 is placed in the recessed groove 63D, the tip end of the valve stem 63 is caulked, so that the washer 69 is connected to the tip end of the valve stem 63. An outside diameter of the washer 69 is larger than the support hole 68, so that the washer 69 restrains the valve stem 63 from falling out of the support plate 67. The support plate 67 is thus placed between the valve plate 62 and the washer 69, so that the valve body 61 is assembled to the support plate 67. A coned disc spring 70 as an elastic member is placed between the support plate 67 and the washer 69. The coned disc spring 70 is configured such that an end on a small-diameter side abuts with the support plate 67 and an end on a large-diameter side abuts with the washer 69. The coned disc spring 70 is sandwiched between the support plate 67 and the washer 69 so as to be elastically deformed. Due to an elastic force of the coned disc spring 70, the back surface 62B of the valve plate 62 in the valve body 61 is pressed against the support plate 67. Hereby, a surface of the support plate 67 on the valve plate 62 side makes surface contact with the back surface 62B of the valve plate 62.

As illustrated in FIGS. 1 and 3, a rotating mechanism 80 for rotating the shaft 64 is connected to the other end of the shaft 64, the other end being placed outside the turbine housing 10. The rotating mechanism 80 includes an arm 81 to which the other end of the shaft 64 is connected, a pin 91 supported by the arm 81, a rod 86 connected to the pin 91, and an actuator 87 for moving the rod 86. The arm 81 is formed in a triangular plate shape, and an engageable hole 83 is formed in one end 82 thereof. The shaft 64 is engaged to the engageable hole 83. As illustrated in FIG. 3, a pin hole 85 for rotatably supporting the pin 91 is formed in the other end 84 of the arm 81. The pin 91 extends so as to penetrate through the pin hole 85, and the other end (a left end in FIG. 3) thereof on an opposite side to one end on the turbine housing 10 side is increased in diameter. The one end (a right end of FIG. 3) of the pin 91 is placed between the arm 81 and the turbine housing 10. The one end of the pin 91 is passed through a locking hole 86A formed in the rod 86, so as to be locked. As illustrated in FIG. 1, the rod 86 is formed in a columnar shape and has a shape in which a middle part is bent. The rod 86 extends from the turbine housing 10 toward the bearing housing 45 side as a whole.

The actuator 87 includes a housing 88, and a driving portion 89 accommodated inside the housing 88. The housing 88 is formed in a bottomed cylindrical shape and is assembled to the compressor housing 50. A via-hole 90A configured such that the rod 86 is passed through its center is formed in a disciform base plate 90. The rod 86 extends into the housing 88 through the via-hole 90A and is connected to the driving portion 89. As indicated by an arrow in FIG. 1, the driving portion 89 moves the rod 86 in a direction where the rod 86 extends. When the actuator 87 moves the rod 86 toward the bearing housing 45 side, the other end 84 of the arm 81 rotates toward the bearing housing 45 side (an A-direction in FIG. 1) around the one end 82, so as to rotate the shaft 64. Hereby, the valve body 61 rotates toward the scroll portion 20 side of the turbine housing 10. As a result, as illustrated in FIG. 5, the valve body 61 abuts with the scroll portion 20 of the turbine housing 10, so as to close respective openings 24A, 25A of the first bypass passage 24 and the second bypass passage 25. Hereby, the wastegate valve 60 enters a closed state, so that all the exhaust gases flowing through the first scroll passage 21 and the second scroll passage 22 flow so as to pass through the turbine wheel 15. Meanwhile, when the actuator 87 moves the rod 86 toward the turbine housing 10 side, the other end 84 of the arm 81 rotates toward the turbine housing 10 side (a B-direction in FIG. 1) around the one end 82, so as to rotate the shaft 64, as illustrated in FIG. 1. Hereby, the valve body 61 rotates in a direction distanced from the scroll portion 20 of the turbine housing 10. As a result, respective openings 24A, 25A of the first bypass passage 24 and the second bypass passage 25 are opened, and the wastegate valve 60 enters an open state, so that the exhaust gases flowing through the first scroll passage 21 and the second scroll passage 22 partially flow so as to detour around the turbine wheel 15. Thus, in the supercharger, the wastegate valve 60 closes and opens respective openings 24A, 25A of the first bypass passage 24 and the second bypass passage 25 by means of one valve body 61, so as to control a boost pressure by adjusting a flow rate of the exhaust gas to pass through the turbine wheel 15.

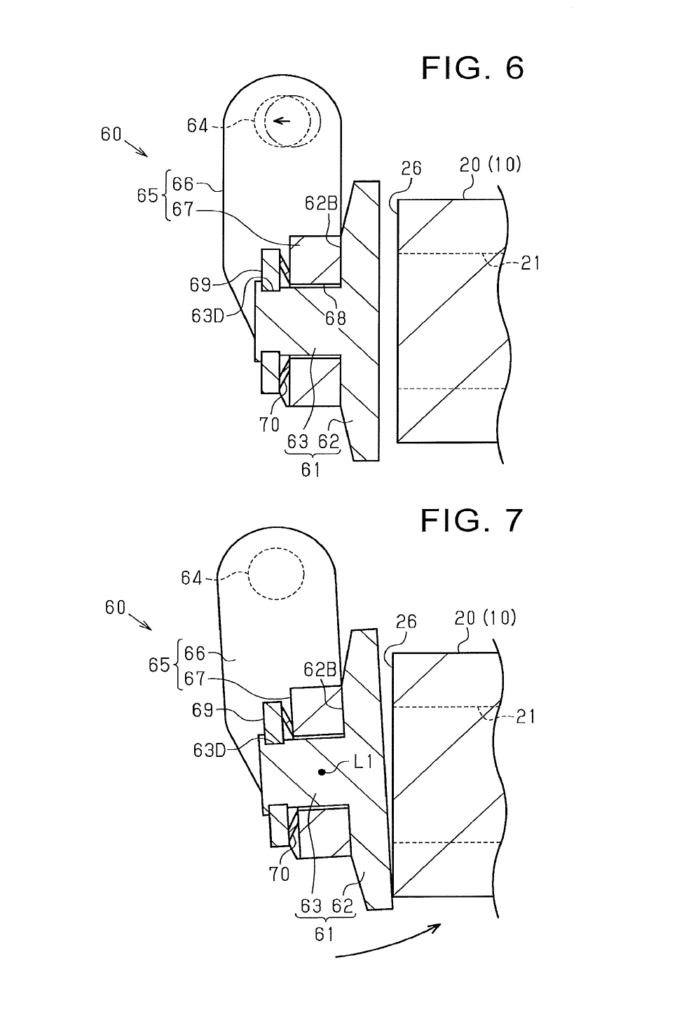

Operations and effects of the present embodiment will be described with reference to FIGS. 6 to 9.

(1) The wastegate valve 60 is configured such that the shaft 64 is rotated so as to rotate the valve body 61 assembled to the shaft 64. In the rotating mechanism 80 that rotates the shaft 64, the rod 86 is moved toward the bearing housing 45 side to rotate the shaft 64, so that the valve body 61 abuts with the scroll portion 20. In such a rotating mechanism 80, a biasing force at the time when the rod 86 is moved also acts on the shaft 64, so that the shaft 64 may be inclined around the bush 55.

As illustrated by an arrow in FIG. 6, when the one end of the shaft 64 moves toward a side distanced from the turbine housing 10 under the influence of such a biasing force, a position of the valve body 61 assembled to the one end of the shaft 64 is also changed to a side distanced from the turbine housing 10.

As illustrated in FIG. 7, in a case where the position of the valve body 61 is changed as such, when the valve body 61 rotates to a valve-closing direction, a whole peripheral edge of the valve plate 62 does not sit on the turbine housing 10 evenly, so that a part (a lower end in FIG. 7) of its rotation locus on the outer peripheral side makes partial contact with the turbine housing 10. In the present embodiment, the clearance C2 between the valve stem 63 and the support portion 65 in the orthogonal direction is made larger than the clearance C1 between the valve stem 63 and the support portion 65 in the axial direction of the shaft 64. Accordingly, the valve body 61 is permitted to be inclined to the support plate 67 around a virtual line L1 parallel to the axial direction of the shaft 64, as a rotation center. Even in a state where the arrangement of the shaft 64 is changed and the part of the valve plate 62 makes partial contact with the turbine housing 10, the shaft 64 is further rotated, so that the valve body 61 is biased toward the turbine housing 10 side by the support plate 67, as indicated by an arrow in FIG. 7. Hereby, the valve body 61 is inclined to the support portion 65, so that the whole peripheral edge of the valve plate 62 is seated on the turbine housing 10.

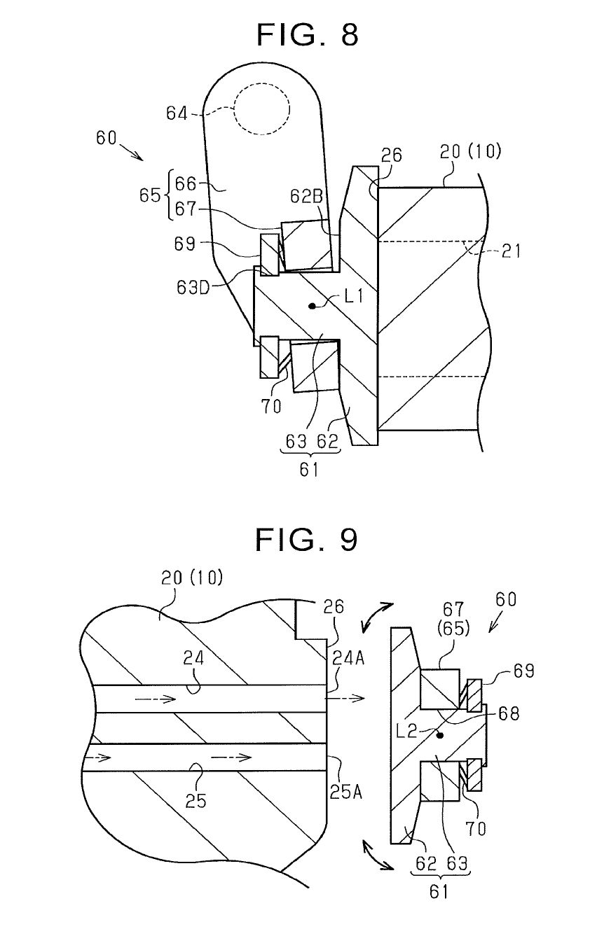

As a result, as illustrated in FIG. 8, the whole peripheral edge of the valve plate 62 can abut with the turbine housing 10, thereby making it possible to secure a sitting property of the valve body 61. As such, in order that the whole peripheral edge of the valve plate 62 sits on the turbine housing 10 from the state where the partial contact of the valve plate 62 occurs, it is necessary to secure the clearance C2 between the valve stem 63 and the support portion 65 in the orthogonal direction. Meanwhile, the clearance C1 between the valve stem 63 and the support portion 65 in the axial direction of the shaft 64 has little influence on the sitting property of the valve body 61 to the turbine housing 10. In the present embodiment, since the clearance C1 provided between the valve stem 63 and the support portion 65 in the axial direction of the shaft 64 and having little influence on the sitting property is made small, it is possible to secure the sitting property of the valve body 61 and it is also possible to restrain movement of the valve body 61 relative to the support portion 65 in the axial direction of the shaft 64, thereby making it possible to restrain vibrations caused due to the movement. Accordingly, it is possible to balance a function to secure the sitting property of the valve body 61 to the turbine housing 10 with a function to restrain vibrations of the valve body 61.

(2) The support hole 68 is formed in an oval shape and the sectional shape of the valve stem 63 is also formed in an oval shape. Accordingly, when the valve stem 63 is inclined to the support plate 67, curved surfaces of the valve stem 63 and the support plate 67 can make contact with each other. This makes it possible to restrain abrasion of the valve stem 63 and the support plate 67, which can contribute to an increase of durability. Further, at the time when the valve stem 63 rotates around its axis, the valve stem 63 is locked by the support plate 67, so that its rotation is restrained. Thus, the valve stem 63 can also serve as a whirl-stop function of the valve body 61.

(3) The coned disc spring 70 is sandwiched between the support plate 67 and the washer 69. The coned disc spring 70 is sandwiched between the support plate 67 and the washer 69 so as to be elastically deformed, and due to a biasing force caused due to its elastic return, the back surface 62B of the valve plate 62 in the valve body 61 is pressed against the support plate 67. Accordingly, in a state where the wastegate valve 60 is opened, inclination of the valve body 61 can be restrained. This accordingly makes it possible to increase the function to restrain vibrations of the valve body 61.

(4) In the present embodiment, the wastegate valve 60 closes and opens respective openings 24A, 25A of the first bypass passage 24 and the second bypass passage 25 by means of one valve body 61. As indicated by an alternate long and short dash line in FIG. 9, when the wastegate valve 60 is opened, the exhaust gas is exhausted from the first bypass passage 24 and the second bypass passage 25 alternately. The exhaust gas thus exhausted collides with the valve body 61.

The opening 24A of the first bypass passage 24 and the opening 25A of the second bypass passage 25 are placed side by side in the axial direction (an up-down direction in FIG. 9) of the shaft 64. Accordingly, as indicated by an arrow in FIG. 9, the exhaust gas works to make the valve body 61 swing around a virtual line L2 parallel to the orthogonal direction (a depth direction in FIG. 9), as a rotation center. In the present embodiment, the clearance C1 between the valve stem 63 and the support portion 65 in the axial direction of the shaft 64 is smaller than the clearance C2 between the valve stem 63 and the support portion 65 in the orthogonal direction, so that movement in the swinging direction is restrained. As such, the openings 24A, 25A are placed side by side in a direction where the function to restrain vibrations of the valve body 61 is easily obtained. Hereby, even if the exhaust gas is exhausted from the openings 24A, 25A alternately, it is possible to effectively restrain vibrations of the valve body 61 by the exhaust gas, thereby making it possible to further effectively obtain the function to restrain vibrations of the valve body 61.

The foregoing embodiment may also be carried out by adding changes as stated below.

(i) The opening 24A of the first bypass passage 24 and the opening 25A of the second bypass passage 25 may not be placed side by side in the axial direction of the shaft 64. For example, a direction where the opening 24A of the first bypass passage 24 and the opening 25A of the second bypass passage 25 are placed side by side may be inclined to the axial direction of the shaft 64. Even in such a case, when the clearance C1 between the valve stem 63 and the support portion 65 in the axial direction of the shaft 64 is made smaller than the clearance C2 between the valve stem 63 and the support portion 65 in the orthogonal direction, it is possible to restrain vibrations of the valve body 61.

(ii) The wastegate valve 60 has a configuration including, as one valve body 61, the valve plate 62 and the valve stem 63 extending linearly so as to penetrate through the support hole 68 from the valve plate 62, but the configuration of the valve body is not limited to this. For example, as one valve body, a first valve plate provided so as to close and open the opening 24A of the first bypass passage 24, a second valve plate provided so as to close and open the opening 25A of the second bypass passage 25, and a valve stem are provided. A branched end of the valve stem on one end side is branched into two such that respective ends thus branched are connected to the first valve plate and the second valve plate, and a merge end on the other end side is passed through the support hole 68. Even with such a configuration, the wastegate valve 60 can close and open respective openings 24A, 25A of the first bypass passage 24 and the second bypass passage 25 by means of one valve body.

(iii) The wastegate valve 60 is configured to close and open respective openings 24A, 25A of the first bypass passage 24 and the second bypass passage 25 by means of one valve body 61, but may close and open the opening 24A of the first bypass passage 24 and the opening 25A of the second bypass passage 25 by respective valve bodies. For example, two support portions may be connected to the shaft 64, so that the opening 24A of the first bypass passage 24 and the opening 25A of the second bypass passage 25 are closed and opened by respective valve bodies assembled to the support portions. Further, two wastegate valves, i.e., a first wastegate valve including a valve body for closing and opening the opening 24A of the first bypass passage 24, and a second wastegate valve including a valve body for closing and opening the opening 25A of the second bypass passage 25 may be provided.

(iv) One of the first bypass passage 24 and the second bypass passage 25 may be omitted. —The above description deals with an example in which the scroll portion 20 includes the first scroll passage 21 and the second scroll passage 22, but the scroll portion 20 may be provided with one scroll passage. In this case, a bypass passage communicating the scroll passage with the inner region of the tubular portion 31 without the accommodation chamber 23 is provided. Then, a wastegate valve is placed so that an opening of the bypass passage can be closed and opened.

(v) The configuration in which the coned disc spring 70 is sandwiched between the support plate 67 and the washer 69 is employed, but in addition to or instead of this configuration, the coned disc spring 70 may be sandwiched between the valve plate 62 and the support plate 67. Note that, in the viewpoint of a heat influence to the coned disc spring 70, it is preferable that the coned disc spring 70 be placed at a position which is more distant from the turbine housing 10 and which receives a small amount of heat from the exhaust gas, that is, at a position between the support plate 67 and the washer 69.

(vi) The coned disc spring 70 is placed such that the end on the small-diameter side abuts with the support plate 67 and the end on the large-diameter side abuts with the washer 69. However, the coned disc spring 70 may be placed such that the end on the large-diameter side abuts with the support plate 67 and the end on the small-diameter side abuts with the washer 69. Further, two coned disc springs 70 can be placed side by side as elastic members. In this case, it is preferable that, in a state where respective ends of the two coned disc springs 70 on a large-diameter side abut with each other in a connected manner, the two coned disc springs 70 be placed at least between the valve plate 62 and the support plate 67 or between the support plate 67 and the washer 69.

(vii) As the elastic member, a constituent other than the coned disc spring 70 can be employed. For example, a leaf spring, a spring washer, and the like may be employed. Further, the elastic member can be omitted.

(viii) The valve stem 63 may be configured to extend from the valve plate 62 into the support hole 68 without penetrating through the support hole 68. Even in this case, when an annular member having elasticity is connected to an inner wall of the support hole 68 and the valve stem 63 is fitted into the annular member, for example, the valve body 61 can be assembled to the support plate 67. Even with such a configuration, if the clearance C2 between the valve stem 63 and the support portion 65 in the orthogonal direction is made larger than the clearance C1 between the valve stem 63 and the support portion 65 in the axial direction of the shaft 64, it is possible to incline the valve body 61 to the support plate 67 around the axial direction of the shaft 64 by elastically deforming the annular member at the time when the wastegate valve 60 is closed.

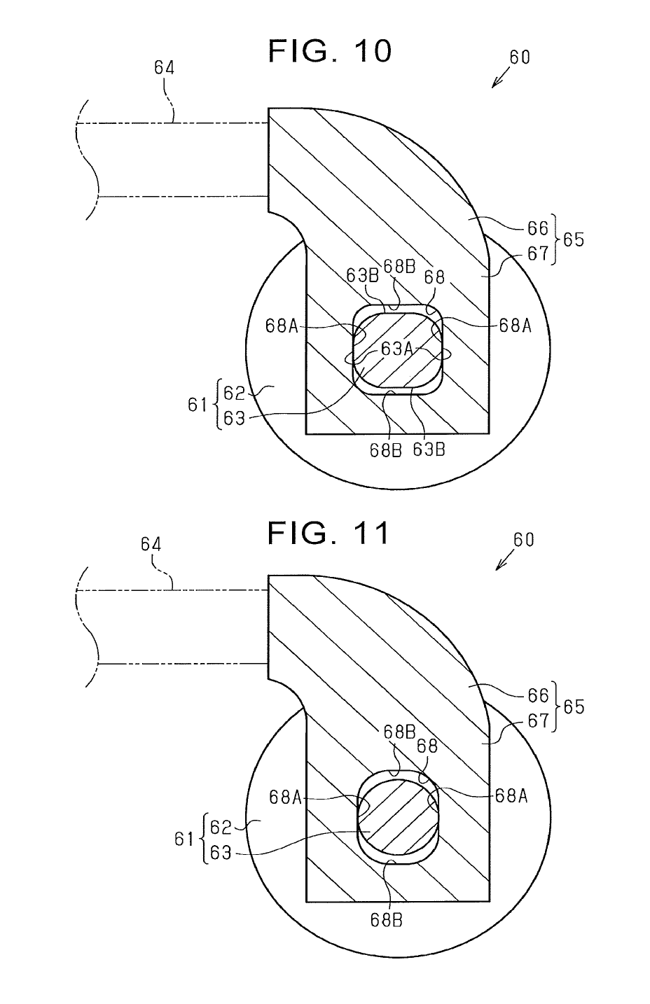

(ix) The configurations of the valve stem 63 and the support hole 68 are not limited to those described above. For example, the sectional shape of the valve stem 63 is formed in an oval shape with its short direction being along the axial direction of the shaft 64 and its longitudinal direction being taken along the orthogonal direction perpendicular to the axial direction. However, the longitudinal direction of the oval shape may be along the axial direction or may be along the orthogonal direction. Further, in terms of the oval shape of the support hole 68, its longitudinal direction may be along the axial direction or may be along the orthogonal direction. Further, as other configurations, configurations illustrated in FIGS. 10 to 12 can be employed, for example.

As illustrated in FIG. 10, the section of the valve stem 63 is formed in an oval shape with its longitudinal direction being along the axial direction (a right-left direction in FIG. 10) of the shaft 64 and its short direction being along the orthogonal direction (an up-down direction in FIG. 10) perpendicular to the axial direction. Further, the support hole 68 formed in the support plate 67 is formed in an oval shape in which lengths in the axial direction of the shaft 64 and the orthogonal direction are equal. A distance between a pair of lateral inner walls 68B in the support hole 68 is longer than a distance between a pair of lateral walls 63B in the valve stem 63. Meanwhile, a distance between a pair of vertical inner walls 68A in the support hole 68 is approximately equal to a distance between a pair of vertical walls 63A in the valve stem 63. Even with such a configuration, when the valve stem 63 is viewed in the axial direction, the clearance C1 between the valve stem 63 and the support portion 65 in the axial direction of the shaft 64 can be made smaller than the clearance C2 between the valve stem 63 and the support portion 65 in the orthogonal direction.

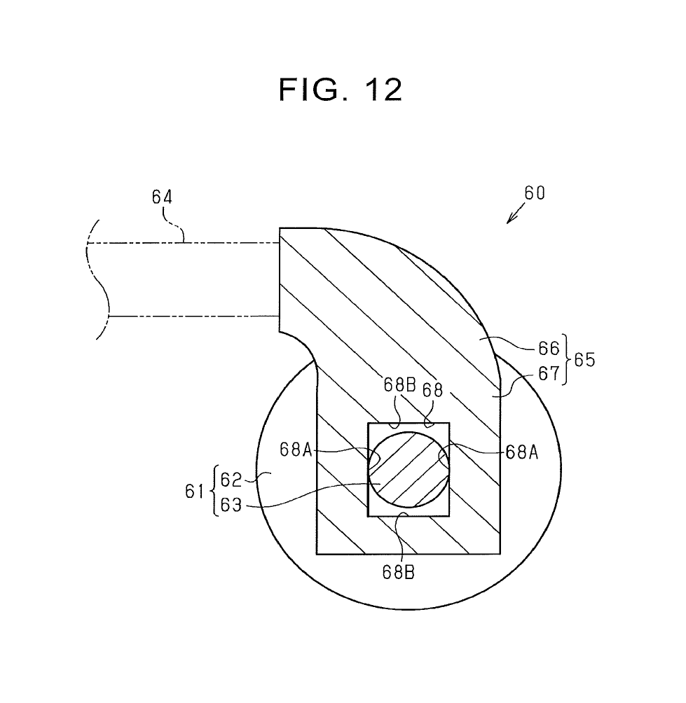

Further, as illustrated in FIG. 11, the section of the valve stem 63 can be formed in a perfect circular shape. In this configuration, the support hole 68 is formed in an oval shape with its short direction being along the axial direction (a right-left direction in FIG. 11) of the shaft 64 and its longitudinal direction being along the orthogonal direction (an up-down direction in FIG. 11) perpendicular to the axial direction. A distance between a pair of lateral inner walls 68B in the support hole 68 is longer than a diameter of the valve stem 63, and a distance between a pair of vertical inner walls 68A in the support hole 68 is substantially equal to the diameter of the valve stem 63. Even with such a configuration, when the valve stem 63 is viewed in the axial direction, the clearance C1 between the valve stem 63 and the support portion 65 in the axial direction of the shaft 64 can be made smaller than the clearance C2 between the valve stem 63 and the support portion 65 in the orthogonal direction.

Further, as illustrated in FIG. 12, the section of the valve stem 63 can be formed in a perfect circular shape, and the support hole 68 can be formed in a rectangular shape. That is, in this configuration, the support hole 68 is formed in a rectangular shape with its short direction being along the axial direction (a right-left direction in FIG. 12) of the shaft 64 and its longitudinal direction being along the orthogonal direction (an up-down direction in FIG. 12) perpendicular to the axial direction. A distance between a pair of lateral inner walls 68B in the support hole 68 is longer than a diameter of the valve stem 63, and a distance between a pair of vertical inner walls 68A in the support hole 68 is substantially equal to the diameter of the valve stem 63. Even with such a configuration, when the valve stem 63 is viewed in the axial direction, the clearance C1 between the valve stem 63 and the support portion 65 in the axial direction of the shaft 64 can be made smaller than the clearance C2 between the valve stem 63 and the support portion 65 in the orthogonal direction.

Further, in each of the above configurations, the distance between the pair of vertical inner walls 68A in the support hole 68 may be made longer than the distance between the pair of vertical walls 63A in the valve stem 63 or the diameter of the valve stem 63. That is, the clearance C1 between the valve stem 63 and the support portion 65 in the axial direction of the shaft 64 may not necessarily be zero. Even in this case, the distance from the lateral inner wall 68B of the support hole 68 to the valve stem 63 may be made longer than the distance from the vertical inner wall 68A of the support hole 68 to the valve stem 63, so that, when the valve stem 63 is viewed in the axial direction, the clearance C1 between the valve stem 63 and the support portion 65 in the axial direction of the shaft 64 may be made smaller than the clearance C2 between the valve stem 63 and the support portion 65 in the orthogonal direction.

Note that, in the configurations illustrated in FIG. 11 or 12, a clearance obtained as a sum of a clearance C1a between a left end of the valve stem 63 on one vertical inner wall 68A side and the one vertical inner wall 68A, and a clearance C1b between a right end of the valve stem 63 on the other vertical inner wall 68A side and the other vertical inner wall 68A may be set as the clearance C1 between the valve stem 63 and the support portion 65 in the axial direction of the shaft 64. Further, a clearance obtained as a sum of a clearance C2a between an upper end of the valve stem 63 on one lateral inner wall 68B side and the one lateral inner wall 68B, and a clearance C2b between a lower end of the valve stem 63 on the other lateral inner wall 68B side and the other lateral inner wall 68B may be set as the clearance C2 between the valve stem 63 and the support portion 65 in the orthogonal direction.

Further, the valve stem 63 can be formed in other shapes such as an elliptical shape and a polygonal shape. Even in such a case, the support hole 68 may be configured in accordance with the sectional shape of the valve stem 63 such that, when the valve stem 63 is viewed in the axial direction, the clearance C1 between the valve stem 63 and the support portion 65 in the axial direction of the shaft 64 is smaller than the clearance C2 between the valve stem 63 and the support portion 65 in the orthogonal direction.

(x) The present embodiment shows an example in which the supercharger is applied to an inline four-cylinder internal combustion engine, but the present disclosure is not limited to this. The configuration similar to the above embodiment can be applied to a supercharger to be used in an inline 6-cylinder or V-type internal combustion engine, and the like.

1. A supercharger comprising:
a turbine housing including a bypass passage configured to cause an exhaust gas to flow so as to detour around a turbine wheel; and
a wastegate valve configured to control an amount of the exhaust gas flowing through the bypass passage, the wastegate valve including a valve body, a support portion, a shaft, and a rotating mechanism,
the valve body including a valve plate, and a valve stem provided in a standing manner from the valve plate in a thickness direction of the valve plate,
the support portion including a support hole through which the valve stem is passed,
the support portion being connected to the shaft,
the rotating mechanism being configured to rotate the shaft, wherein:
(i) the valve body is assembled to the support portion in a state where the valve stem is passed through the support hole;
(ii) the valve body is configured to rotate along with rotation of the shaft; and
(iii) when the valve stem is viewed in an axial direction of the valve stem, a clearance between the valve stem and the support portion in the axial direction of the shaft is smaller than a clearance between the valve stem and the support portion in an orthogonal direction perpendicular to the axial direction of the shaft.

2. The supercharger according to claim 1, wherein
the support hole has an oval shape; and
a sectional shape of the valve stem is formed in an oval shape.

3. The supercharger according to claim 1, wherein
the valve stem extends from the valve plate so as to penetrate through the support hole;
a connecting plate is connected to a tip end projecting from the support portion; and
an elastic member is sandwiched at least between the valve plate and the support portion or between the support portion and the connecting plate.

4. The supercharger according to claim 1, wherein
(i) the turbine housing includes a first scroll passage and a second scroll passage each configured to lead the exhaust gas to the turbine wheel;
(ii) the bypass passage includes a first bypass passage and a second bypass passage, the first bypass passage being branched from a middle of the first scroll passage and configured to cause the exhaust gas to flow so as to detour around the turbine wheel, and the second bypass passage being branched from a middle of the second scroll passage and configured to cause the exhaust gas to flow so as to detour around the turbine wheel;
(iii) an opening of the first bypass passage and an opening of the second bypass passage are placed side by side in the axial direction of the shaft; and
(iv) the wastegate valve is configured to close and open respective openings of the first bypass passage and the second bypass passage by means of one valve body, so as to control respective amounts of the exhaust gases flowing through the first bypass passage and the second bypass passage.
